(19) United States
(12) Patent Application Publication
(10) Pub. No.: US 2009/0016794 A1
(43) Pub. Date: Jan. 15, 2009

(54) CHARGE NEUTRALIZATION AND SHEET PROCESSING APPARATUS

(75) Inventors: Isao Yahata, Izunokuni-shi (JP); Hiroyuki Taki, Izunokuni-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/099,695

(22) Filed: Apr. 8, 2008

Related U.S. Application Data
(60) Provisional application No. 60/949,487, filed on Jul. 12, 2007.
(60) Provisional application No. 60/968,856, filed on Aug. 29, 2007.

(51) Int. Cl. G03G 15/00

(52) U.S. Cl. 399/405

(57) ABSTRACT

A charge neutralization according to one aspect of the invention is equipped with a charge neutralization which performs charge removal as it is brought in close proximity to or into contact with a major surface of a sheet when the sheet passes it in moving in a prescribed first direction, and escape portions located at edge confronting positions of the charge neutralization that are to be opposed to edges of the sheet in a second direction that crosses the first direction, for reducing abrasion due to contact with the sheet.

### CROSS-REFERENCE TO RELATED APPLICATIONS

This application claims the benefit of U.S. Provisional Application No. 60/949,487, filed Jul. 12, 2007 and No. 60/968,856, filed Aug. 29, 2007.

### BACKGROUND OF THE INVENTION

1. Field of the Invention

The present invention relates to a charge neutralization and a sheet processing apparatus and, for example, to the removal of static electricity from a sheet-like medium such as a sheet.

2. Description of the Related Art

In sheet processing apparatus which process a sheet-like medium such as a sheet of paper, such as printing apparatus and post-processing apparatus, a medium may be charged during the course of such processing as sheet transport, charging, or fusing. If a medium is charged, the medium is stuck to a member of the apparatus, which is a cause of improper execution of such processing as sheet transport, rearrangement, or dropping. In particular, in a processing apparatus in which plural sheets are subjected to such processing as sheet transport, rearrangement, or dropping in a state that they are laid on each other, the sheets laid on each other may be stuck to each other, which is a cause of improper execution of such processing. This results in occurrence of a jam or a processing failure.

In view of the above, apparatus have been developed in which a charge neutralization such as a charge neutralizing brush or a charge neutralizing sheet is provided to remove static electricity. The charge neutralization, which, for example, is a member using a band-like unwoven fabric or a planting-type brush-like member, removes static electricity from a medium (sheet) by generating a corona discharge with the charge neutralization somewhat spaced from the charged medium or bringing the charge neutralization into contact with the charged medium.

3. Problems of the Related Art

However, the above-described technique has the following problems. That is, when the charge neutralization comes into contact with a medium, it may cause resistance to transport of the medium. Where the charge neutralization is a brush, the brush may be cut and damaged or unraveled by an edge of a medium through contact with the medium. For example, these result in problems that medium transport processing is not performed properly and that the brush is caught on a medium.

### BRIEF SUMMARY OF THE INVENTION

A charge neutralization according to one aspect of the present invention comprises a charge neutralization which performs charge removal as it is brought in close proximity to or into contact with a major surface of a sheet when the sheet passes it in moving in a prescribed first direction; and escape portions which are provided at edge confronting positions of the charge neutralization that are to be opposed to edges of the sheet in a second direction that crosses the first direction, and reduce resistance of contact with the sheet.

A sheet processing apparatus according to another aspect of the invention comprises a processing tray which forms a sheet bundle by rearranging sheet-like media in a width direction and in a vertical direction; a buffering tray having a pair of tray members which are disposed above the processing tray so as to be separated from each other in the width direction, the tray members being capable of moving in the width direction between first positions for placement of the sheet on themselves and second positions for dropping of the sheet once placed on the tray members through between themselves onto the processing tray; a tray drive mechanism which moves the tray members to the first positions or the second positions in synchronism with each other; a roller mechanism which is disposed in the vicinity of a rear end of the buffering tray and supplies the sheet onto the buffering tray; an arm which is disposed in the vicinity of the roller mechanism, is rotated and elevated and thereby guides the sheet to the buffering tray when the sheet is supplied from the roller mechanism to the buffering tray, and pushes the sheet toward the processing tray as it is rotated and lowered in a state that the sheet has been supplied onto the buffering tray when the tray members are moved from the first positions to the second positions; a charge neutralization which is provided on the tip side of the arm, performs charge removal as it is brought in close proximity to or into contact with a major surface of the sheet when the sheet passes it in moving in a prescribed first direction, and has escape portions which are provided at edge confronting positions to be opposed to edges in a second direction that crosses the first direction and which prevent contact with the sheet; and an arm drive mechanism which drives the arm to rotate and elevate it or rotate and lower it.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a schematic diagram showing the configuration of a multi-function peripheral according to one embodiment of the present invention;

FIG. 2 is a perspective view schematically showing a post-processing apparatus according to the embodiment of the invention;

FIG. 3 is a side view showing the internal configuration of the post-processing apparatus according to the embodiment;

FIG. 4 is a perspective view of an active drop part according to the embodiment;

FIG. 5 is a perspective view of the active drop part according to the embodiment;

FIG. 6 is a perspective view of part of a post-processing apparatus according to the embodiment;

FIG. 7 is a perspective view of an arm and a charge neutralization according to the embodiment;

FIG. 8 is a block diagram showing the configuration of a control part according to the embodiment;

FIG. 9 is a perspective view of a charge neutralization according to the embodiment;

FIG. 10 is a perspective view of a charge neutralization according to the embodiment;

FIG. 11 is an explanatory diagram showing a processing step of a stapling mode and a sorting mode in the post-processing apparatus according to the embodiment;

FIG. 12 is an explanatory diagram showing a processing step of the stapling mode and the sorting mode in the post-processing apparatus according to the embodiment;

FIG. 13 is an explanatory diagram showing a processing step of the stapling mode and the sorting mode in the post-processing apparatus according to the embodiment;

FIG. 14 is an explanatory diagram showing a processing step of the stapling mode and the sorting mode in the post-processing apparatus according to the embodiment;

FIG. 15 is an explanatory diagram showing a processing step of the stapling mode and the sorting mode in the post-processing apparatus according to the embodiment;

FIG. 16 is an explanatory diagram showing a processing step of a non-sorting mode in the post-processing apparatus according to the embodiment;

FIG. 17 is a front view of a charge neutralization according to another embodiment of the invention;

FIG. 18 is a front view of a charge neutralization according to another embodiment of the invention;

FIG. 19 is a front view of a charge neutralization according to another embodiment of the invention;

FIG. 20 is a front view of a charge neutralization according to another embodiment of the invention;

FIG. 21 is a front view of a charge neutralization according to another embodiment of the invention;

FIG. 22 is a front view of a charge neutralization according to another embodiment of the invention;

FIG. 23 is a perspective view of a charge neutralization according to another embodiment of the invention; and

FIG. 24 is a perspective view of a charge neutralization according to another embodiment of the invention.

### DETAILED DESCRIPTION OF THE INVENTION

### Embodiment 1

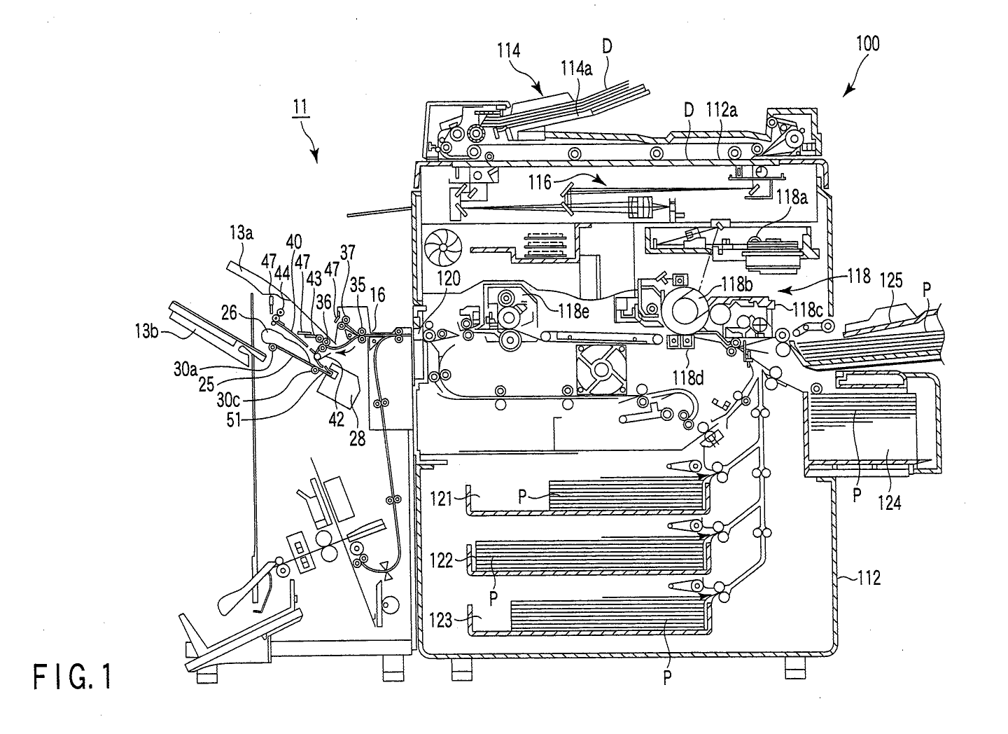

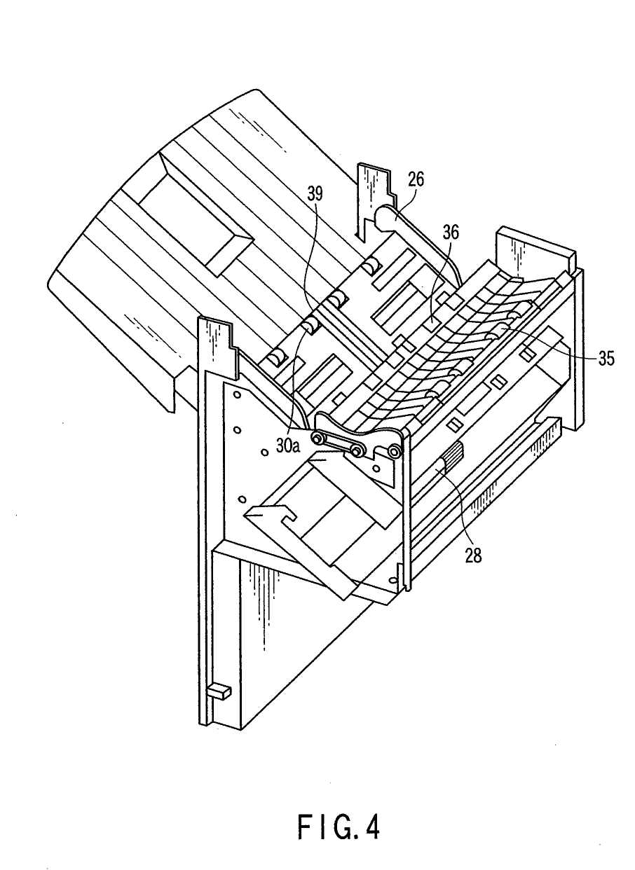

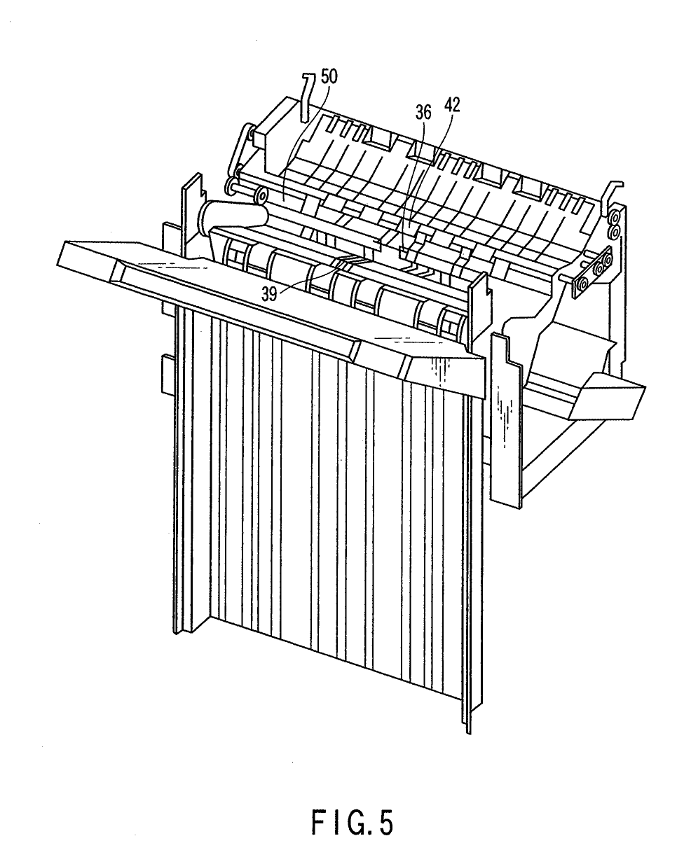

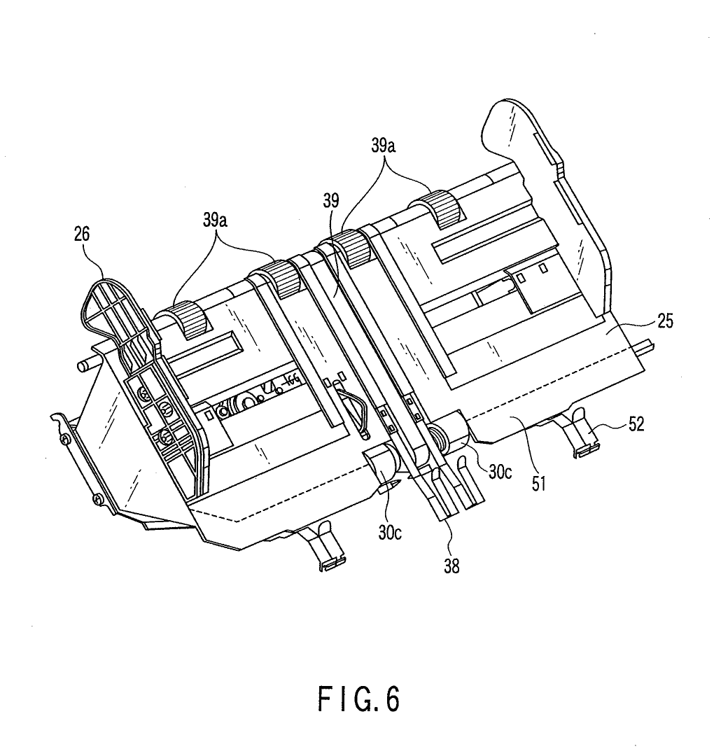

A post-processing apparatus as a sheet processing apparatus according to a first embodiment of the present invention will be hereinafter described with reference to FIGS. 1-10. In each drawing, a configuration is drawn schematically by making enlargement, reduction, or abbreviation if necessary.

FIG. 1 is a schematic diagram of a multi-function peripheral (hereinafter referred to simply as MFP) 10. The MFP 10 is composed of a post-processing apparatus 11 according to the embodiment of the invention, a digital copier 100 to which the post-processing apparatus 11 is connected, and other devices. The digital copier 100 is an example of an MFP main body, a term used in the invention.

The digital copier 100 has an apparatus outer case 112 and a platen 112a which is a transparent glass plate disposed as a top plate of the outer case 112. An automatic document feeder 114 (hereinafter referred to simply as ADF 114) is provided over the platen 112a in an openable manner. The ADF 114 operates so as to feed an original document D automatically to a prescribed position on the platen 112a.

For example, if a copying start switch is depressed after setting an original document D on a sheet supply tray 114a of the ADF 114 and setting whether to perform stapling, a manner of stapling, the number of copies, a sheet size, etc., the original document D on the sheet supply tray 114a is fed automatically to the document reading position on the platen 112a on a page-by-page basis. After being read, each page of the original document is ejected automatically with proper timing.

A scanner unit 116, a printer unit 118, cassettes 121, 122, and 123 for copy sheets P (hereinafter referred to simply as sheets P), etc. are disposed inside the outer case 112. A large-capacity feeder 124 which houses a large number of sheets of the same size and a manual feed tray 125 are attached to the right-hand wall (as viewed in the figure) of the outer case 112. Furthermore, the post-processing apparatus 11 (described later) is connected to the left-hand wall of the outer case 112.

The scanner unit 116 acquires image information of an original document D that has been fed to the document reading position on the platen 112a by the ADF 114 by illuminating and scanning it, reading resulting reflection light, and performing photoelectric conversion.

The printer unit 118 energizes a laser 118a according to the image information that has been read by the scanner unit 116 and forms an electrostatic latent image corresponding to the image information on the circumferential surface of a photoconductive drum 118b. Then, the printer unit 118 visualizes the electrostatic latent image on the photoconductive drum 118b by supplying toner to it through a developing unit 118c and transfers a resulting toner image to a sheet P by means of a transfer charger 118d. At this time, the sheet P is supplied from one of the cassettes 121, 122, and 123, the large-capacity feeder 124, and the manual feed tray 125.

Furthermore, the printer unit 118 supplies the toner-image-transferred sheet P to a fusing device 118e, fuses the toner image onto the sheet P by heat-melting it, and ejects the sheet P to the post-processing apparatus 11 via an ejection unit 120. The sheet P which is ejected via the ejection unit 120 corresponds to a sheet as a term used in the invention.

The post-processing apparatus 11 will be described below. The post-processing apparatus 11 is disposed adjacent to the digital copier 100 which is an example of the MFP main body. The post-processing apparatus 11 is an apparatus for forming sheet bundles P′ by accumulating and rearranging, for each copy, sheets P that have been subjected printing in the digital copier 100 and performing post-processing such as stapling on the sheets P. The stapling is processing of rearranging plural accumulated sheets P and stapling them at their one end.

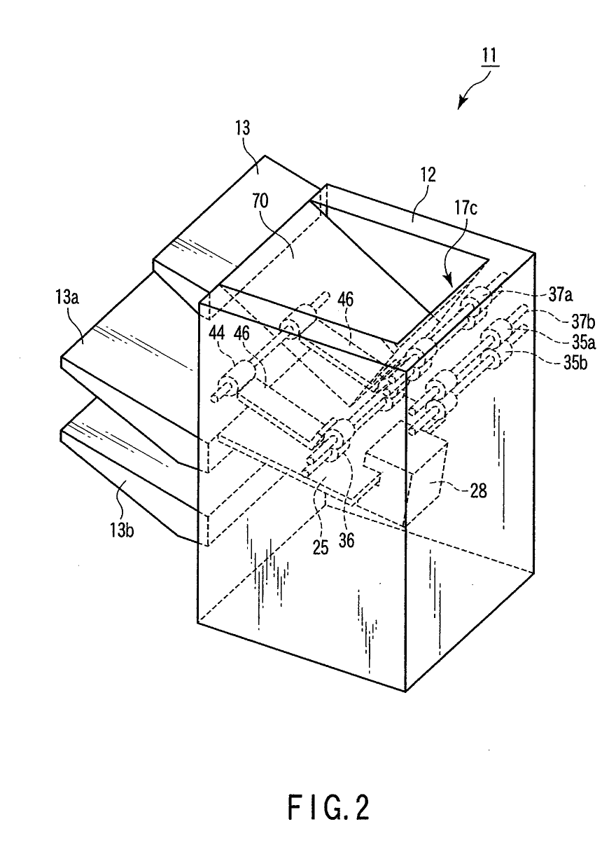

As shown in FIGS. 1 and 2, the post-processing apparatus 11 is provided with a case 12 and a top tray 13a and a bottom tray 13b which are attached to the case. The top tray 13a and the bottom tray 13b can hold sheets P or a sheet bundle P′ that has been subjected to post-processing (described later) and ejected. The case 12 is provided with a supply opening 16 through which to receive a sheet P that has been subjected to printing in the MFP main body and ejection openings 17a, 17b, and 17c through which a post-processed sheet bundle P′ or sheets P are ejected. Three transport paths are formed from the supply opening 16 to the three ejection openings 17a, 17b, and 17c.

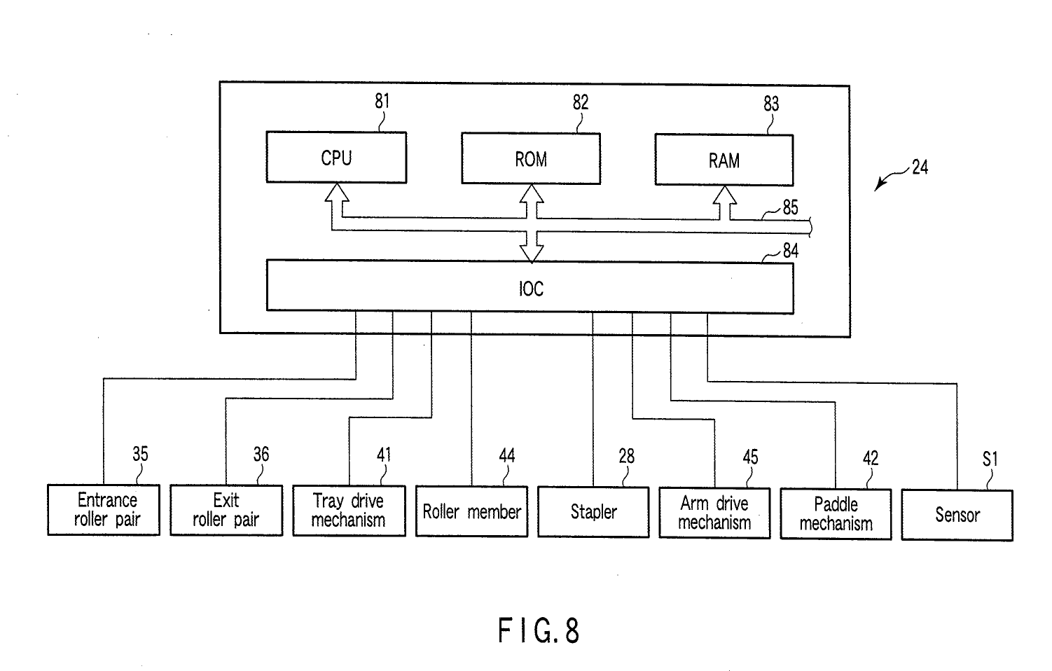

A post-processing apparatus 21 configured to post-process sheets P, a transport part 22 configured to supply a sheet P to the post-processing apparatus 21, an active drop part 23 which is disposed between the post-processing apparatus 21 and the transport part 22, and other parts are housed inside the case 12. The parts 21, 22, and 23 are controlled by a control part 24 (see FIG. 8) which is equipped with a microprocessor, memories, etc. and has computer functions.

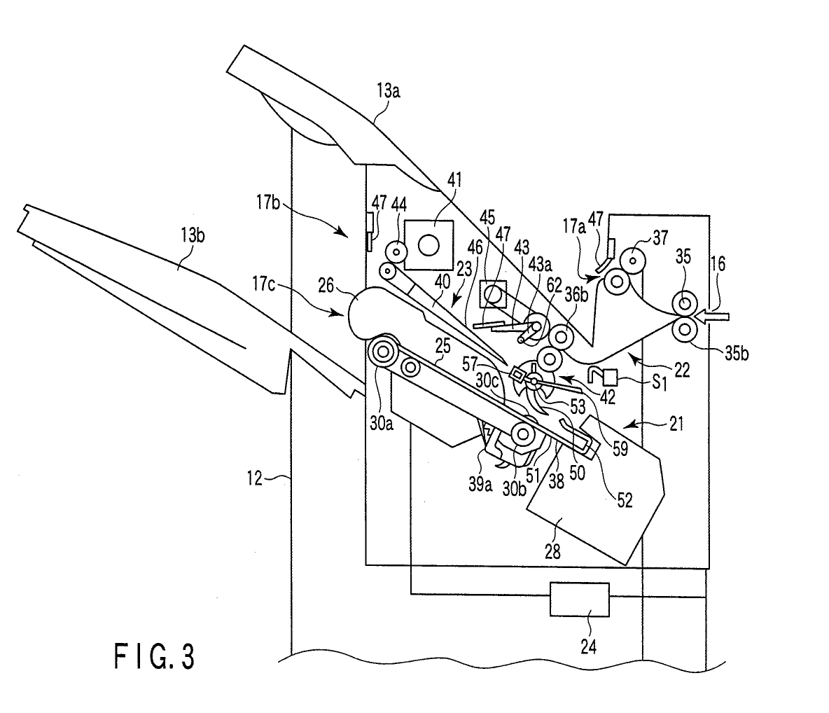

As shown in FIGS. 3-7, the post-processing apparatus 21 includes a processing tray 25, a rearranging mechanism 51, a stapler 28, transport rollers 30a and 30c, etc. The processing tray 25 is inclined in such a manner that its rear end portion, i.e., the side close to the stapler 28, is lower. In other words, the processing tray 25 is disposed in such an inclined posture that its front side (left side in FIG. 1) is located obliquely above.

Equipped with horizontal rearranging plates 26 and vertical rearranging rollers 30c, the rearranging mechanism 51 has a function of forming a sheet bundle P′ by rearranging plural sheets P on the processing tray 25 in a width direction and a vertical direction that is perpendicular to the width direction. A sheet bundle P′ consisting of a prescribed number of sheets P is formed by the rearranging mechanism 51. The stapler 28 is to staple a sheet bundle P′ being held on the processing tray 25.

Wound with a belt, the transport rollers 30a and 30c can be rotated in the same direction in a synchronized manner by a motor (not shown). An ejection mechanism 38 for transporting a post-processed sheet bundle P′ toward the top tray 13a is disposed at the center, in the width direction, of the processing tray 25.

The transport part 22 is equipped with a transport passage 34 for a sheet P, a first roller pair 35 which is disposed in the vicinity of the supply opening 16, that is, on the upstream side in the transport passage 34, and a second roller pair 36 which is disposed on the downstream side in the transport passage 34. The second roller pair 36 is an example of a roller mechanism, a term used in the invention.

The first roller pair 35 includes a top roller 35a and a bottom roller 35b. The second roller pair 36 includes a bottom drive roller 36a and a top pinch roller 36b. A sensor S1 (detector) for detecting the tail of a sheet P is disposed in the transport passage 34. The sensor S1 is a contact operation type sensor such as a microswitch. Position information such as a transport position of a sheet is detected by the sensor S1.

The active drop part 23 is equipped with a buffering tray 40 which is disposed above the processing tray 25, a buffering tray drive mechanism 41, a paddle mechanism 42, a bias arm 43, an arm drive mechanism 45, a roller member 44 which is disposed above the buffering tray 40, and other things.

The roller member 44 is used in ejecting a sheet P through the ejection opening 17b without doing post-processing. The roller member 44 can be rotation-driven by a rotation mechanism (not shown) and also can be moved in the vertical direction by an elevation mechanism. More specifically, the roller member 44 is elevated by the elevation mechanism when a sheet P is supplied onto the buffering tray 40 from the second roller pair 36 or a sheet P is to be dropped onto the processing tray 25 from the buffering tray 40. When a sheet P which need not be subjected to post-processing is to be ejected directly from the buffering tray 40 through the ejection opening 17b, the roller member 44 transports the sheet P from the buffering tray 40 toward the ejection opening 17b as it is rotated by the rotation mechanism.

The buffering tray 40 is composed of a pair of tray members 46 which are two divisional members arranged in the sheet width direction (the width direction of a sheet P) (second direction) which is perpendicular to the sheet transport direction (first direction). Each tray member 46 is separated upward from and opposed to the processing tray 25. The tray members 46 are moved in the opposite directions in the width direction of the processing tray 25 in a synchronized manner.

The tray drive mechanism 41 can move the pair of tray members 46 with respect to each other in the width direction of a sheet P in a synchronism with each other between first positions (closed positions) for placement of a sheet P on the buffering tray 40 and second positions (open position) for dropping of a sheet P from the buffering tray 40 onto the processing tray 25.

The paddle mechanism 42 has a short paddle 58 and a long paddle 59. The short paddle 58 functions as a paddle member which is rotated on a first shaft 53 and thereby pushes the rear end portion of a sheet P downward when the tray members 46 of the buffering tray 40 have moved from the first positions (closed positions) to the second positions (open positions). The long paddle 59 has a function of rubbing a sheet P on the processing tray 25 toward the stapler 28.

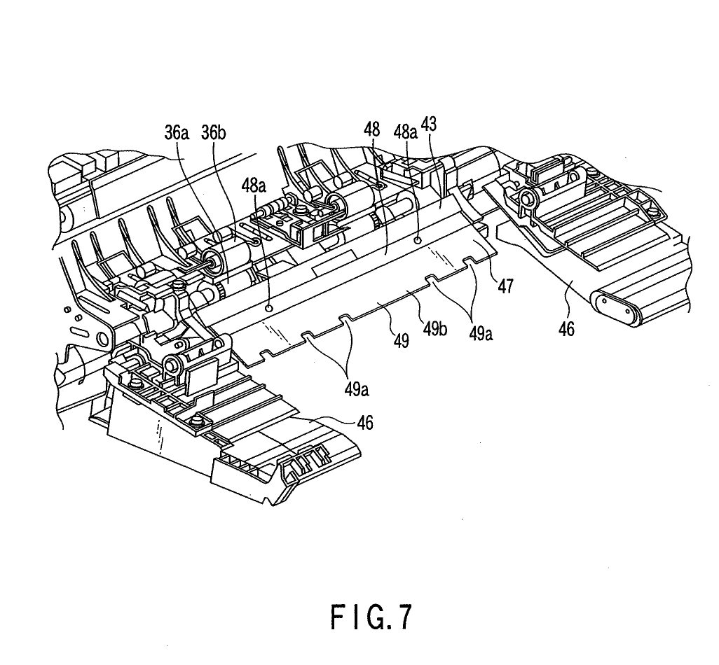

As shown in FIGS. 3 and 7, the bias arm 43 can be rotated on a rotary shaft 65 extending in the sheet width direction and its tip side is provided with a plate-like member which is inclined so as to hang down obliquely forward toward the processing tray 25. The bias arm 43 has functions of, for example, making way for a sheet being transported or-biasing downwarded a sheet that has been transported as the tip portion of the bias arm 43 is moved under an angular control of a control unit 24.

The bias arm 43 is configured so as to be able to be operated by drive force from the arm drive mechanism 45. The arm drive mechanism 45 is driven by actuator such as a stepping motor, a DC motor, or a solenoid (not shown) under the control of the control part 24, and transmits drive power to the bias arm 43. The arm drive mechanism 45 also functions as a pressure adjusting part which can adjust the state of pressing of a charge neutralization 47 against a sheet P and as a position adjusting part which adjusts the position of the charge neutralization 47 on the basis of position information of a sheet so that the charge neutralization 47 is located at the same position as the end portion of the sheet. When the arm drive mechanism 45 is driven to activate an assist lever 43a (which serves for position adjustment of the bias arm 43) and the sheet P hits a receiving member 62 provided in the assist lever 43a, the bias arm 43 is rotated on the shaft 65 and thereby elevated. In a state that the bias arm 43 has been rotated and elevated, a sheet P can be guided to the buffering tray 40.

On the other hand, if the receiving member 62 of the assist lever 43a is disengaged the bias arm 43 is rotated on the shaft 65 and thereby lowered under the control of the control part 24. The rotated and lowered bias arm 43 performs a function of preventing a sheet P on the buffering tray 40 from being loosened or curled. The bias arm 43 also has a function of pushing the rear end portion of the sheet P toward the processing tray 25 when the pair of tray members 46 are moved from the first positions (closed positions) to the second positions (open positions).

The buffering position, in the width direction, of the bias arm 43 can be changed being controlled by the control part 24 on the basis of sheet information (sheet size, thickness, etc.) acquired by the MFP main body. Therefore, the contact angle of or the non-contact distance between the charge neutralization (described later) and a sheet being transported can be varied. The charge neutralization 47 is attached to the tip of the bias arm 43.

Likewise, the ejection openings 17b and 17c are provided with respective charge neutralizations 47. Each of these charge neutralizations 47 is fixed to the inside surface of the case of the post-processing apparatus by screwing or sticking, and is brought into contact with one surface of a sheet P being ejected.

The charge neutralization 47 provided at each of the three locations is configured in such a manner that a base portion of a charge neutralizing sheet 49 made of unwoven fabric of conductive fiber is held between and bonded to plate-like metal support members 48. The charge neutralizing sheet 49 performs self-discharge-type charge removal for removing static electricity from a sheet, a film, or the like. The support members 48 are provided with attaching portions 48a for attachment of the charge neutralization 47 on both sides in the width direction.

The charge neutralizing sheet 49 extends in the sheet width direction and is inclined in the sheet transport direction (first direction) so that its tip portion is opposed to one surface (front surface or back surface) of a sheet P. When a charged sheet P is transported, the charge neutralizing sheet 49 is brought into contact with or in close proximity to the surface (major surface) of the sheet and removes static electricity through charge removal or corona discharge.

As shown in FIGS. 7, 9, and 10, escape portions 49a for reducing the resistance of contact with a sheet P are formed at the tip edge of the charge neutralizing sheet 49. The escape portions 49a, each of which has a prescribed width of about 2 cm, for example, are formed by cutting so that their edges escape from both edges of a sheet by a prescribed distance which is about 1 cm, for example.

Therefore, the tip portion of the charge neutralizing sheet 49 has gaps and hence is like comb teeth. Because of the presence of the escape portions 49a, gaps are formed between the charge neutralizing sheet 49 and a sheet. Furthermore, since the gaps formed by the escape portions 49a have the prescribed width, tip portions 49b of the unwoven fabric that are adjacent to each other via the escape portions 49a do not rub against each other.

The escape portions 49a are located at edge confronting positions that are to be opposed to positions to be passed by corner-inclusive edges, in the width direction (second direction), of a sheet P. That is, when a sheet P passes, the escape portions 49a form gaps at the positions that are opposed to the sheet edges in the width direction. This can reduce or prevent contact abrasion of the edges of the sheet P and the charge neutralizing sheet 49 and prevent the sheet edges from being caught on the charge neutralizing sheet 49. Therefore, the charge neutralizing sheet 49 is prevented from being damaged by sheet edges.

The edge of each tip portion 49b of the charge neutralizing sheet 49 assumes a straight line extending in the width direction. This secures portions of contact with a sheet P and hence provides a sufficient charge removal effect. Each tip portion 49b may be like comb teeth whose widths are smaller than or equal to the width of the escape portions 49a (see FIGS. 20 and 22).

The plural escape portions 49a are formed according to the sizes of plural kinds of media to be processed. The escape portions are formed at positions to be opposed to the edges of plural kinds of sheets P to be processed in both cases that the transport reference is the center line of a sheet and that it is one edge of a sheet. That is, the escape portions are formed at positions to be opposed to both edges having a sheet transport area or the sheet center as a reference and positions to be opposed to one reference edge of each of plural kinds of sheets and the other edge.

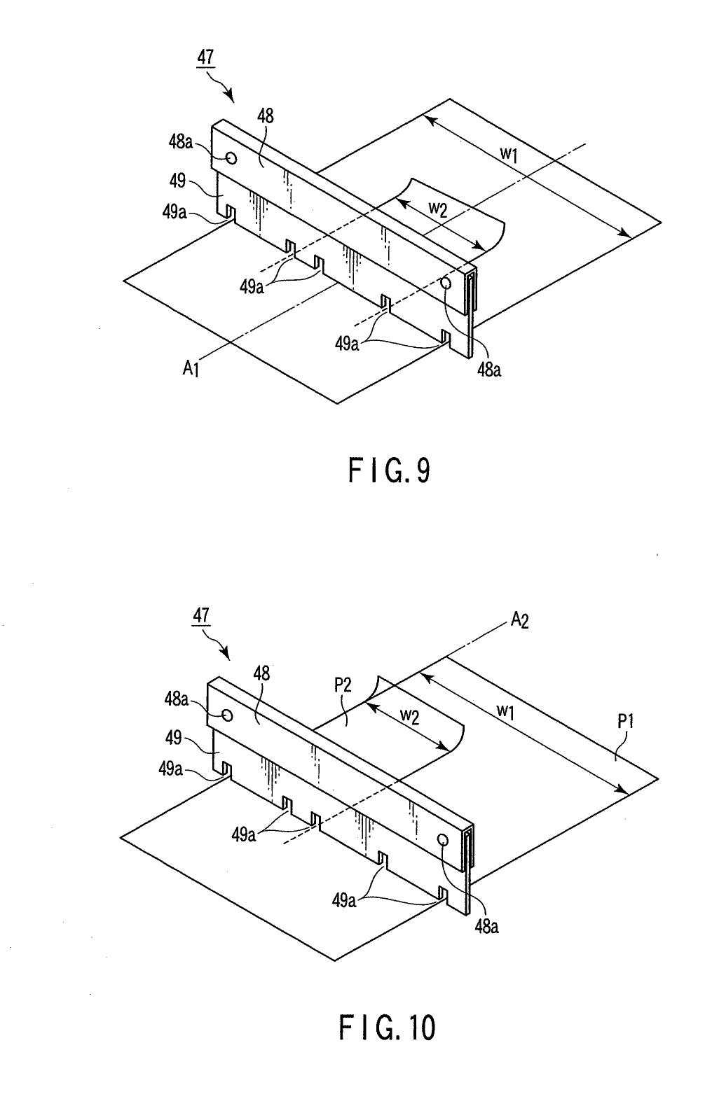

FIG. 9 shows a relationship between sheets and the escape portions 49a in the case where two kinds of sheets P1 and P2 are arranged with their center line as a reference. FIG. 10 shows a relationship between sheets and the escape portions 49a in the case where the same kinds of sheets P1 and P2 are arranged with one edge of each of the two kinds of sheets P1 and P2 as a reference. The widths of the sheets P1 and P2 are represented by W1 and W2, respectively.

It is seen that in either case escape portions 49a are located at the edges of a sheet in all of three modes described later.

As for sheet size examples, there are a sheet size system (hereinafter referred to as “A system”) according to JIS (Japanese Industrial Standards) which is mainly used in Japan and includes the A4 size and the B4 side and a sheet size system (hereinafter referred to as “LT system”) which is mainly used in Europe and the US and includes the legal size and the letter size. However, the sheet sizes are not limited to these.

The contact pressure of the charge neutralization 47 that is provided at the tip of the bias arm 43 is controlled on the basis of sheet information. Therefore, when, for example, a fragile, thin sheet has been transported, so as not to obstruct its transport, it is possible to set the buffering position of the bias arm 43 higher than the ordinary position and perform charge removal by corona discharge.

On the other hand, when a strong, thick sheet has been transported, charge removal may be performed positively by setting the buffering position of the bias arm 43 lower than the ordinary position and causing contact to the sheet. These measures make it possible to perform charge removal efficiently for plural kinds of sheets.

The bias arm 43 can be moved in the second direction, that is, in the sheet width direction, on the basis of the position of a sheet being transported, and its buffering position can be varied according to a sheet transport state under the control of the control part 24. This always enables charge removal at an effective position. As a result, electrostatic absorption between sheets on the buffering tray can be prevented and plural sheets P can be accumulated on the buffering tray stably.

The position of the charge neutralization 47 can thus be adjusted under the control of the control part. For example, it is possible to perform charge removal at a position that is most suitable for a sheet being transported by moving the bias arm 43 in the width direction on the basis of position information relating to a sheet transport position which is acquired by the sensor S1 or the MFP 10.

For example, the control part 24 which is shown in FIG. 8 is equipped with a CPU 81, a ROM 82, a RAM 83, an IOC (input output controller) 84, and an internal bus 85 which connects these devices. For example, the IOC 84 is connected to the first roller pair 35, the second roller pair 36, the tray drive mechanism 41, the roller member 44, the stapler 28, the arm drive mechanism 45, the paddle mechanism 42, the sensor S1, etc. via plural drivers (not shown). Position information of the tail of a sheet P detected by the sensor S1 or the like and such information as a size and the number of sheets P supplied from the digital copier 100 (MFP main body) are input to the control part 24.

The control part 24 can arbitrarily set angles, timing, etc. of rotational elevation and lowering of the bias arm 43 by controlling the arm drive mechanism 45. This makes it possible to cause rotational elevation and lowering of the bias arm 43 under optimum conditions according to a sheet type (thickness and size).

Furthermore, the control part 24 can adjust the position of the charge neutralization by controlling the position of the bias arm 43 by controlling the arm drive mechanism 45 on the basis of position information of the tail of a sheet P detected by the sensor S1 or the like and such information as a size and the number of sheets P supplied from the digital copier 100 (MFP main body).

The operation of the post-processing apparatus 11 will be described below with reference to FIGS. 11-15.

### <First Processing Mode (Stapling Mode)>

A description will be made of a first transport path for stapling of plural copies which is performed after plural sheets P are rearranged or sorted.

First, a sheet P is sent from the MFP 10 in an arrow direction in FIG. 11. The sheet is put into the post-processing apparatus through the first roller pair 35 and transported to the second roller pair 36. The sheet that is transported from rollers 36a and 36b is stored temporarily on the buffering tray 40. While the first sheet is buffered on the buffering tray 40, a second sheet P is likewise transported to the buffering tray. However, if no sheets of the preceding job are stacked on the processing tray, it is not necessary to store sheets on the buffering tray 40. If no sheets of the preceding job are stacked on the processing tray or are being processed, it is not necessary to store sheets on the buffering tray. If sheets of the preceding job are stacked on the processing tray and the processing has not completed yet, sheets are buffered temporarily on the buffering tray. The number of sheets that are buffered on the buffering tray 40 to secure a post-processing time may be varied as appropriate according to the sheet processing speed of the connected digital copier 100 (MFP).

FIG. 11 shows a state that the first sheet P is placed on the buffering tray 40 and the second sheet P is being supplied to the buffering tray 40. The sheet P is moved along the transport passage 34 toward the second roller pair 36 while activating the sensor S1 which is disposed at the halfway position of the transport passage 34. At this time, the bias arm 43 has been rotated and elevated and guides the sheet P to the buffering tray 40. And the tray members 46 of the buffering tray 40 are located at the first positions (closed positions) and hence sheets P can be placed on the buffering tray 40.

The pair of (i.e., right and left) tray members 46 (see FIG. 2) support both end portions, in the width direction, of each sheet P. A sheet receiving seat 57 of the paddle mechanism 42 supports a central portion, in the width direction, of a rear end portion of each sheet P.

On the other hand, as shown in FIG. 11, on the processing tray 25, a prescribed number of sheets P that were supplied to the processing tray 25 beforehand are rearranged in the width direction and the vertical direction by the rearranging mechanism and stapling is performed on a resulting sheet bundle P′ if necessary.

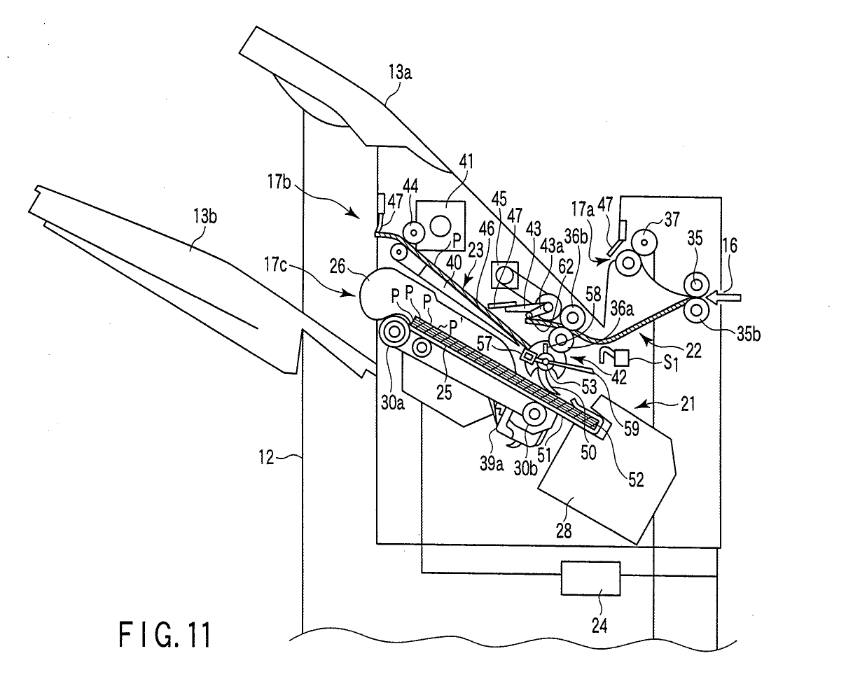

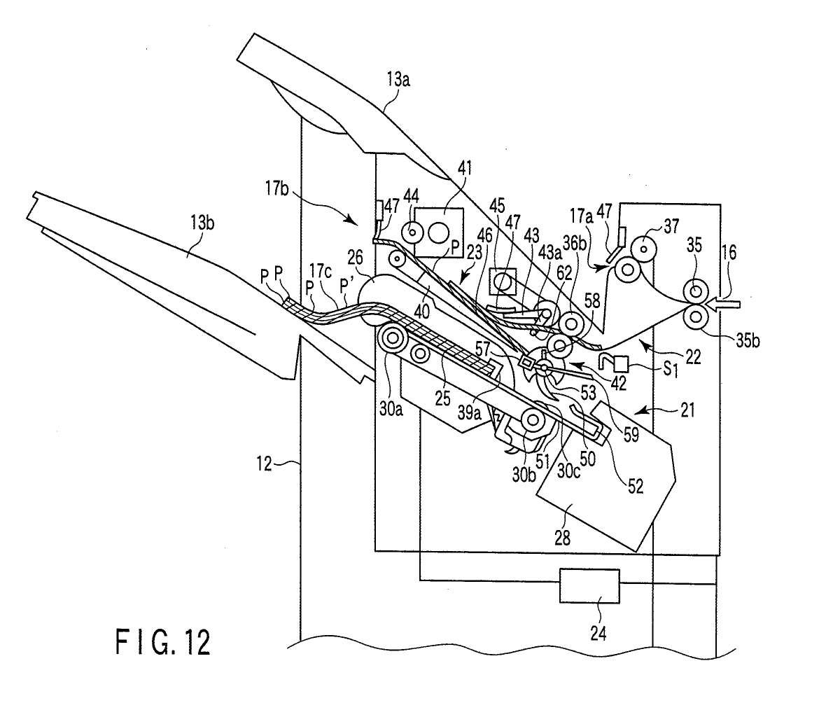

As shown in FIG. 12, the second sheet P is supplied onto the buffering tray 40 from the second roller pair 36 while being guided by the bias arm 43. When the tail of the sheet P has just passed the sensor S1, the sensor S1 sends the control part 24 a signal indicating that the tail of the sheet P has just passed it.

As the sheet P passes under the bias arm 43, charge is removed from the sheet P by the charge neutralizing sheet 49 of the charge neutralization 47 which is disposed on the left of (as viewed in the figure) the roller 44 if the head portion of the sheet P is in contact with or in close proximity to the charge neutralization 47. At this time, since escape portions 49a are formed at the positions corresponding to the edges of the sheet (see FIG. 8), the corners or the edges of the sheet are prevented from contacting the charge neutralizing sheet 49. Therefore, the charge neutralizing sheet 49 is prevented from being damaged whereas the sheet is transported satisfactorily.

On the other hand, on the processing tray 25, a sheet bundle P′ that has been stapled is transported to the ejection opening 17c.

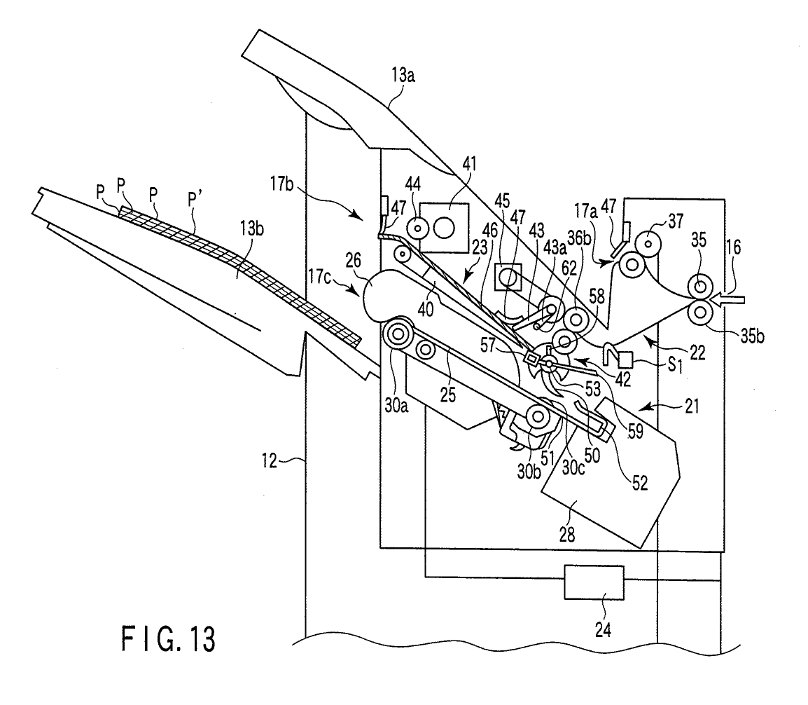

As shown in FIG. 13, when the two sheets P have been accumulated on the buffering tray 40, the bias arm 43 is rotated and lowered by the arm drive mechanism 45 toward the sheets P on the buffering tray 40. The rotational lowering of the bias arm 43 is done by activating the arm drive mechanism 45 after a lapse of a prescribed time from a time point when the control part 24 receives a signal corresponding to the tail of the sheet P. The bias arm 43 prevents the rear end portions of the sheets P from being curled or loosened irrespective of the kind, thickness, and printing patterns of the sheets P. As the two sheets P are accumulated on the buffering tray 40, the preceding sheet bundle P′ is ejected and transported toward the paper ejection tray 13b by the ejection mechanism 38 and its loading on the paper ejection tray 13b is completed.

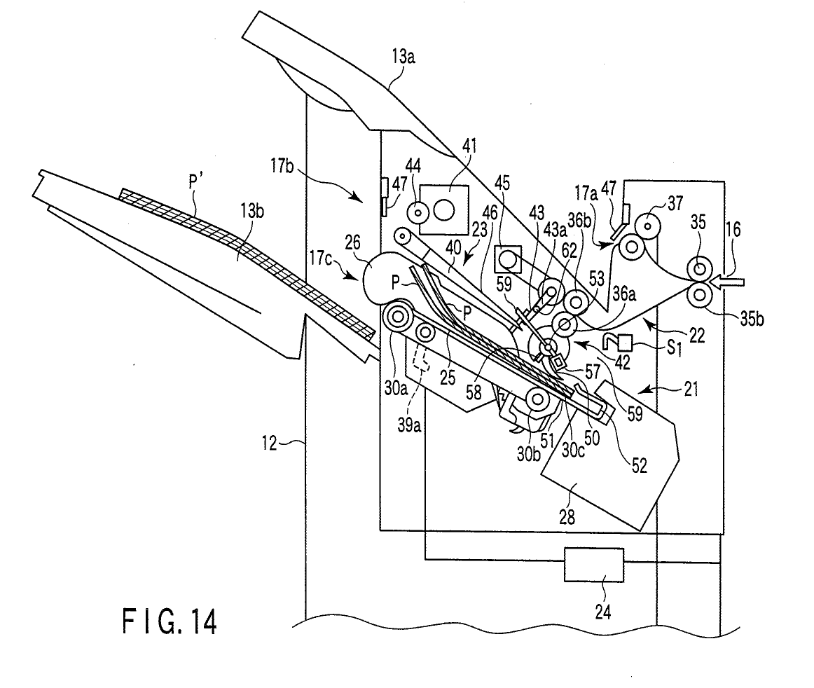

Subsequently, as shown in FIG. 14, the tray drive mechanism 41 is activated, whereby the tray members 46 of the buffering tray 40 are moved from the first positions (closed positions) to the second positions (open positions).

As the tray members 46 are moved from the first positions (closed positions) to the second positions (open positions), the paddle mechanism 42 is rotated. That is, as shown in FIG. 14, the sheet receiving seat 57 is rotated on the second shaft 65 and comes not to support the rear end portions of the sheets P. The short paddle 58 and the long paddle 59 are also rotated in the same direction.

As a result, the two sheets P drop because of their own weights through between the pair of tray members 46 and the short paddle 58 hits the top surface of the sheets P to assist the dropping of the sheets P. Furthermore, the support of the bias arm 43 is canceled by an action of the assist arm 43a, whereby the bias arm 43 operates to push the rear end portions of the sheets downward (indicated by an arrow in the figure) as the sheets drop and thereby assists the dropping of the sheets P.

The above description is directed to the case that the sheets P are laid with such orientation that they are long in the width direction.

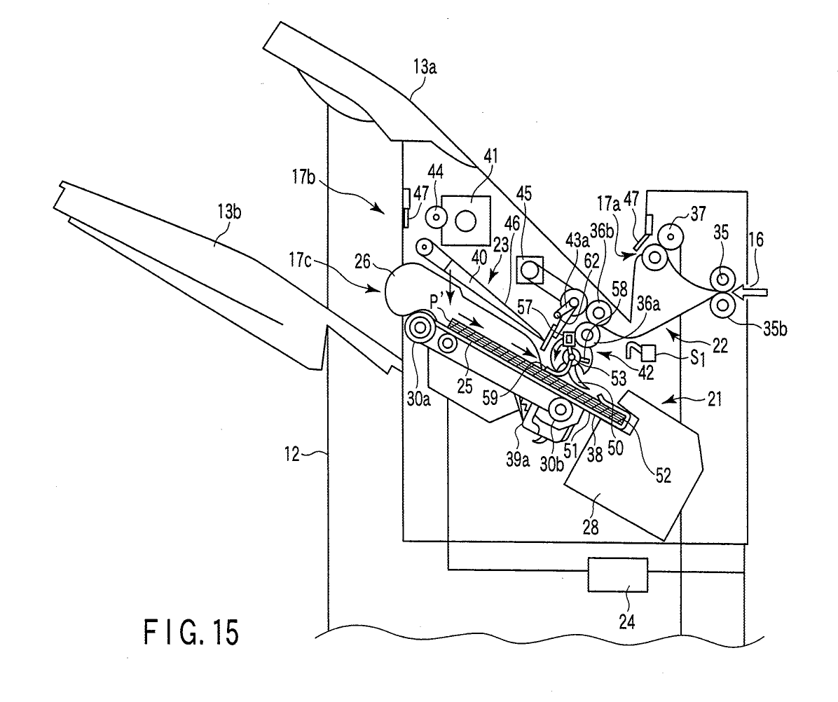

As shown in FIG. 15, the sheets P that have dropped onto the processing tray 25 are sent to toward the stapler 28. The tails of the sheets are guided toward a tail stopper 52 while the sheets are guided by a sheet guide 50 and the processing tray 25. Since the processing tray 25 is inclined in such a manner that its rear end portion (i.e., the side close to the stapler 28) is lower, the sheets P that have dropped onto the processing tray 25 slide down in such a manner that their rear end portions go toward the stopper 52. The lower sheet P on the processing tray 25 is transported toward the stopper 52 because of rotation of the transport rollers 30a and 30c. As for the upper sheet P on the processing tray 25, its movement toward the stopper 52 is promoted by the sheet guide 50 and a scratching operation of the long paddle 59 of the paddle mechanism 42.

After the two sheets P have been loaded onto the processing tray 25 in the above manner, following sheets P are supplied sequentially to the processing tray 25 from the second roller pair 36 with the buffering tray 40 left at the second positions (open positions). That is, sheets P that are output from the second roller pair 36 are guided to the processing tray 25 without being placed on the buffering tray 40. These sheets P are sequentially laid on the sheets P that were placed on the processing tray 25 beforehand. The sheets P are rearranged in the width direction and the vertical direction by the rearranging mechanism 51, whereby a sheet bundle P′ is formed. More specifically, the sheets are rearranged in the horizontal direction by the horizontal rearranging plates 26, and are rearranged in the vertical direction by causing the tails of the sheets P to butt against the tail stopper 52 by the paddle mechanism 42 and the vertical rearranging rollers 30c. Sheets that arrive one after another are guided into the stopper 52 in the above-described manner. When a prescribed number or more of sheets have been accumulated, the sheet guide 50 is moved to increase the gap between itself and the processing tray 25.

After a final page has been rearranged and a sheet bundle P′ consisting of a prescribed number of sheets P has been formed on the processing tray 25, the stapler 28 is moved to a prescribed position (e.g., a sheet corner or plural positions along a sheet edge) and stapling is performed.

As shown in FIG. 13, the sheet bundle P′ is pushed out by the ejection mechanism 38, transferred to a bundle nail 39a which is provided in a bundle nail belt 39, and moved together with the ejection mechanism 38. The sheet bundle P′ is ejected to the paper ejection tray 13b through the ejection opening 17c.

As described above, two following sheets P can be stored on the buffering tray 40 while post-processing (e.g., stapling) is being performed on a sheet bundle P′ on the processing tray 25. That is, since arrival of sheets P at the processing tray 25 can be delayed, time necessary for post-processing on a sheet bundle P′ can be secured and the post-processing can be performed without causing a delay due to the processing time of the post-processing.

### <Second Processing Mode (Sorting Mode)>

Next, a sorting mode operation of the entire post-processing apparatus will be described with reference to FIGS. 11-15. In a sorting mode, as shown in FIG. 11, when a sheet P is sent from the MFP to the supply opening 16 in the arrow direction, the sheet is put into the post-processing apparatus 21 through the rollers 35a and 35b and transported to the second roller pair 36. Sheets P that are transported from the second roller pair 36 are stored temporarily on the buffering tray 40.

Then, as shown in FIG. 14, the buffer tray 40 is opened, whereby the stored sheets drop and are thereby supplied onto the processing tray 25.

As shown in FIG. 14, on the processing tray 25, the sheets are rearranged by the horizontal rearranging plates 26, the paddle 42, and the vertical rearranging rollers 30c in the same manner as in the above-described stapling mode and are sorted by the horizontal rearranging plates 26. At the time of sorting, sheets are shifted in one direction by 15 mm, for example, in the width direction.

Then, the sheets are pushed out by the ejection mechanism 38, transferred to the bundle nail 39a of the bundle nail belt 39, and ejected to the paper ejection tray 13b together with the ejection mechanism 38.

In the sorting mode, sheets can be ejected in a divisional manner by a small number of (one to four) sheets (i.e., sheets stacked on the processing tray) each time.

### <Third Processing Mode (Non-Sorting Mode)>

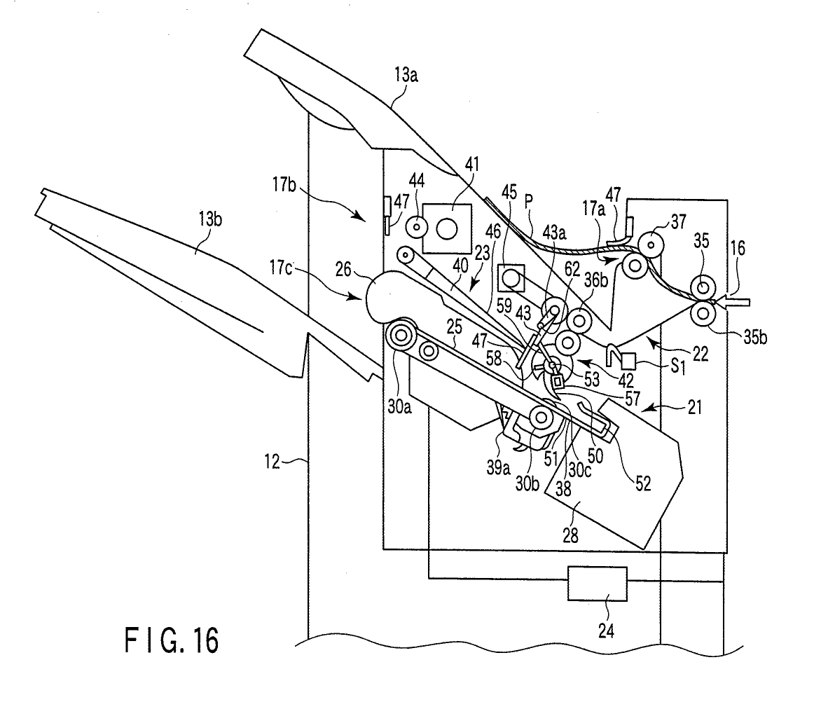

Next, a non-sorting mode operation of the entire post-processing apparatus will be described with reference to FIG. 16. In a non-sorting mode, after a sheet is put into the post-processing apparatus 11 through the rollers 35, the sheet is transported to a nip of discharge rollers 37 provided above the buffering tray 40 and non-sorting-ejected to the top tray 13a without being subjected to any processing.

In passing through the nip of discharge rollers 37, the sheet P is subjected to charge removal by the charge neutralizing sheet 49 of a charge neutralization 47. At this time, since as shown in FIG. 7 the escape portions 49a are formed at the positions corresponding to the edges of the sheet P, the corners and the edges of the sheet are prevented from contacting the charge neutralizing sheet 49. Therefore, the charge neutralizing sheet 49 is prevented from being damaged whereas the sheet is transported satisfactorily.

Where it is not necessary to delay the arrival of sheets P at the processing tray 25 as in the case where stapling is not performed, sheets P that are output from the second roller pair 36 may be dropped immediately onto the processing tray 25 by locating the buffering tray 40 at the second positions (open positions) when a first sheet P is output from the second roller pair 36.

The sheet processing apparatus according to the embodiment provides the following advantages. Since the escape portions 49a are formed at the edge passing positions according to the types (sizes) of sheets P, the charge neutralization can be prevented from obstructing transport of a sheet. Therefore, the charge neutralization can be prevented from being damaged through contact with a sheet whereas a sufficient area of surface contact with a sheet is secured. As a result, a sheet transfer failure can be prevented and good processing performance can be secured.

Since the charge neutralization 47 is attached to the bias arm 43, charge removal can be performed effectively as the bias arm 43 operates. As such, the bias arm 43 can secure high stability of sheet loading onto the buffering tray 40 and can also secure sufficient charge removal performance while reducing the resistance between the charge neutralizing sheet and a sheet. Furthermore, since the charge neutralizing sheet can continue to be in contact with a sheet until the sheet is loaded onto the buffering tray, a high charge removal effect can be obtained.

Various kinds of sheets are transported from the MFP 10. Even if a fragile, thin sheet is transported and buckles between the arm and the buffering tray 40, the charge removal effect is not lowered because the bias arm 43 operates. In particular, although the sheet charge amount is further increased in the case of high-speed processing, the invention enables effective charge removal.

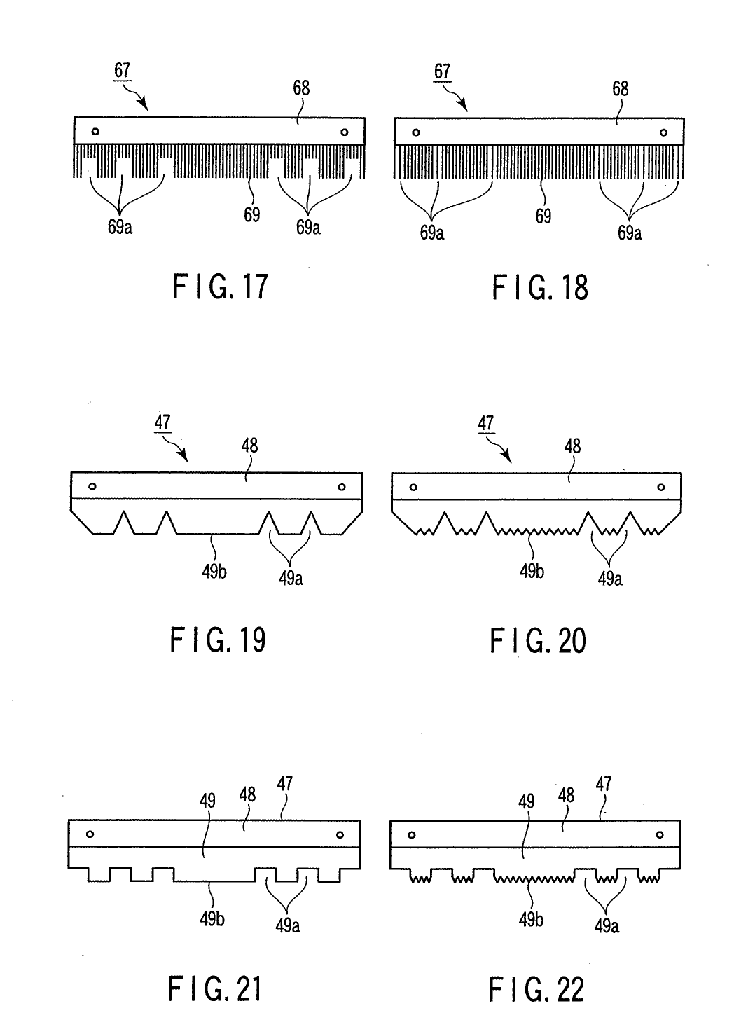

The invention is not limited to the above-described embodiment. For example, although in the first embodiment the charge neutralization 47 uses the charge neutralizing sheet 49 made of unwoven fabric, a charge neutralizing brush 69 as shown in FIG. 17 may be used. In this case, like the charge neutralizing sheet 49 according to the first embodiment, the charge neutralizing brush 69 is configured in such a manner that a large number of fibrous members each being a conductive fiber are buried between and their base portions are held between and bonded to plate-like metal support members 68. In the charge neutralizing brush 69, escape portions 69a are formed by shorter fibers than the other tip portions 69b.

As a further alternative, as shown in FIG. 18, in the charge neutralizing brush 69, the escape portions 69a may be formed so as not to contact the edges of a sheet by setting the brush fiber density lower than in the other portions or planting no brush fibers there.

The structure of the escape portions 49a or 69a formed at the tip edge of the charge neutralization are not limited to the above. For example, as shown in FIGS. 19 and 20, escape portions may be formed into triangular shapes (tapered shapes) by cutting. Furthermore, as shown in FIGS. 21 and 22, escape portions 49a may be formed at the ends of the charge neutralization 47.

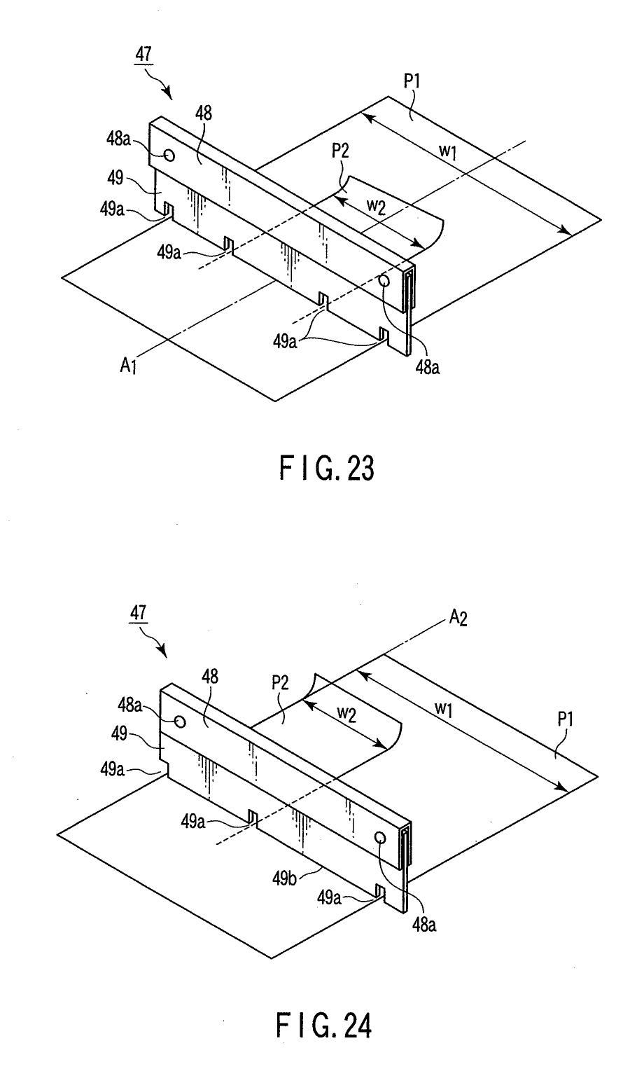

Although in the above embodiment the escape portions 49a of the charge neutralization 47 are formed at both of the positions that are determined with the center of sheets as a reference and the positions that are determined with one edge of each sheet as a reference, the invention is not limited to such a case. For example, as shown in FIGS. 23 and 24, the charge neutralization 47 may be such that the escape portions 49a are formed only at the positions that are determined with the center (A1) of sheets as a reference or only at the positions that are determined with an edge (A2) of each sheet as a reference.

In this case, since the number of escape portions 49a is small, a larger contact area can be obtained and a higher charge removal effect can be attained.

The invention is not limited to the above embodiments. It goes without saying that in practicing the invention constituent elements of the invention can be modified in various manners in terms of the specific shapes of individual constituent members and other points without departing from the spirit or scope of the invention. Although the embodiments of the invention have been described for the charge neutralization provided in the paper ejection and loading unit of the post-processing apparatus, the same advantages can be obtained even if it is provided in a sheet transport path of the MFP main body.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A charge neutralization comprising:
a charge neutralization which performs charge removal as it is brought in close proximity to or into contact with a surface of a sheet when the sheet passes it in moving in a prescribed first direction; and
escape portions which are provided at edge confronting positions of the charge neutralization that are to be opposed to edges of the sheet in a second direction that crosses the first direction, and reduce resistance of contact with the sheet.

2. The charge neutralization according to claim 1, wherein the escape portions are provided at plural edge confronting positions that are arranged in the second direction and are to be opposed to respective edges of plural kinds of media to be subjected to charge removal, and the edge confronting positions are positions that are always passed by both edges of a sheet when the sheet is transported.

3. The charge neutralization according to claim 2, wherein the plural escape portions are provided on both sides with a center line of the media in the second direction as a reference.

4. The charge neutralization according to claim 2, wherein the plural escape portions are provided at positions that are to be opposed to an edge, on the other side in the second direction, of another sheet with an edge, on one side, of a sheet having a largest dimension in the second direction among the plural kinds of media as a reference and an edge, on the one side, of the sheet having the largest dimension.

5. The charge neutralization according to claim 1, wherein the charge neutralization has a charge neutralizing sheet that is made of a conductive material and assumes a sheet-like shape, and wherein the escape portions are formed by cutting the charge neutralizing sheet at the edge confronting positions.

6. The charge neutralization according to claim 1, wherein the charge neutralization has plural conductive linear members and assumes a brush shape, and wherein the escape portions are formed in such a manner that the linear members are shorter at the edge confronting positions than in the other regions.

7. The charge neutralization according to claim 1, wherein the charge neutralization has plural conductive linear members and assumes a brush shape, and wherein the escape portions are formed in such a manner that the linear members have a lower density at the edge confronting positions than in the other regions.

8. A sheet processing apparatus comprising:
a processing tray which forms a sheet bundle by rearranging sheet-like media in a width direction and in a vertical direction;
a buffering tray having a pair of tray members which are disposed above the processing tray so as to be separated from each other in the width direction, the tray members being capable of moving in the width direction between first positions for placement of the sheet on themselves and second positions for dropping of the sheet once placed on the tray members through between themselves onto the processing tray;
a tray drive mechanism which moves the tray members to the first positions or the second positions in synchronism with each other;
a roller mechanism which is disposed in the vicinity of a rear end of the buffering tray and supplies the sheet onto the buffering tray;
a bias arm which is disposed in the vicinity of the roller mechanism, is rotated and elevated and thereby guides the sheet to the buffering tray when the sheet is supplied from the roller mechanism to the buffering tray, and pushes the sheet toward the processing tray as it is rotated and lowered in a state that the sheet has been supplied onto the buffering tray when the tray members are moved from the first positions to the second positions;
the charge neutralization according to claim 1 which is provided on the tip side of the arm, performs charge removal as it is brought in close proximity to or into contact with a major surface of the sheet when the sheet passes it in moving in a prescribed first direction, and has escape portions which are provided at edge confronting positions of the sheet to be opposed to edges in a second direction that crosses the first direction and which prevent contact with the sheet; and
an arm drive mechanism which drives the arm to rotate and elevate it or rotate and lower it.

9. The sheet processing apparatus according to claim 8, further comprising a pressure adjusting part capable of adjusting a state of pressing of the charge neutralization against the sheet.

10. The sheet processing apparatus according to claim 8, further comprising:
a roller member which removes a sheet that is not used for formation of a sheet bundle from the buffering tray and ejects it out of the apparatus; and
a charge neutralization which is disposed in the vicinity of the roller member, performs charge removal as it is brought in close proximity to or into contact with a major surface of the sheet when the sheet passes it in moving in a prescribed first direction, and has escape portions which are provided at edge confronting positions of the sheet to be opposed to edges in a second direction that crosses the first direction and which prevent contact with the sheet.

11. The sheet processing apparatus according to claim 8, wherein the buffering tray is skipped if no sheets of a preceding job are stacked on the processing tray or are being processed.

12. The sheet processing apparatus according to claim 8, wherein media are buffered temporarily on the buffering tray if sheets of a preceding job are stacked on the processing tray and the processing has not completed yet.

13. The sheet processing apparatus according to claim 8, wherein the arm drive mechanism adjusts a state of contact of the charge neutralization with the sheet by driving the arm to rotate and elevate it or rotate and lower it on the information of the sheet.

14. The sheet processing apparatus according to claim 8, further comprising a detector which detects a transport position of the sheet, wherein the arm drive mechanism adjusts a position of the arm in the second direction according to the position of the sheet.

15. A charge neutralizing method for performing charge removal by bringing a charge neutralization in close proximity to or into contact with a surface of a sheet-like sheet, the charge neutralization having, on its tip side, escape portions which reduce resistance of contact with the sheet, the charge neutralizing method comprising:
transporting the sheet in a prescribed first direction on the tip side of the charge neutralization; and
disposing the escape portions so that their positions correspond to edges, in a second direction that crosses the first direction, of the sheet being transported.

16. The charge neutralizing method according to claim 15, further comprising adjusting a state of pressing of the charge neutralization against the sheet.

17. The charge neutralizing method according to claim 15, comprising:
disposing the escape portions at plural edge confronting positions that are arranged in the second direction and are to be opposed to respective edges of plural kinds of media to be subjected to charge removal; and
disposing the plural escape portions on both sides with a center line of the media in the second direction as a reference.

18. The charge neutralizing method according to claim 15, further comprising:
disposing the escape portions at plural edge confronting positions that are arranged in the second direction and are to be opposed to respective edges of plural kinds of media to be subjected to charge removal; and
disposing the plural escape portions at positions that are to be opposed to an edge, on the other side in the second direction, of another sheet with an edge, on one side, of a sheet having a largest dimension in the second direction among the plural kinds of media as a reference and an edge, on the one side, of the sheet having the largest dimension.
